(19) United States
(12) Patent Application Publication
(10) Pub. No.: US 2016/0100605 A1
(43) Pub. Date: Apr. 14, 2016

(54) CHEWING GUM PRODUCTS CONTAINING ETHYL ESTER OF N-[[5-METHYL-2-(1-METHYLETHYL)-CYCLOHEXYL] CARBONYL] GLYCINE

(71) Applicants: Sonya S. Johnson, La Grange Highlands, IL (US); Gloria T. Sheldon, Valparaiso, IN (US); Derek Held, Oak Park, IL (US); Daniel J. Zyck, North Riverside, IL (US)

(72) Inventors: Sonya S. Johnson, La Grange Highlands, IL (US); Gloria T. Sheldon, Valparaiso, IN (US); Derek Held, Oak Park, IL (US); Daniel J. Zyck, North Riverside, IL (US)

(73) Assignee: WM. WRIGLEY JR. COMPANY, Chicago, IL (US)

(21) Appl. No.: 14/970,971

(22) Filed: Dec. 16, 2015

Related U.S. Application Data
(63) Continuation of application No. 13/704,893, filed on Mar. 18, 2013.
(60) Provisional application No. 61/356,083, filed on Jun. 18, 2010.
(60) Provisional application No. 61/478,185, filed on Apr. 22, 2011.

(51) Int. Cl. A23G 4/06; A23G 4/20

(52) U.S. Cl. CPC A23G 4/06; A23G 4/20; A23V 2002/00

(57) ABSTRACT

A chewing gum composition includes gum base, flavor, sweetening agent, and about 0.3% to about 0.6% ethyl ester of N-[[5-methyl-2-(1-methylethyl)-cyclohexyl]carbonyl]glycine, commonly known as WS-5.

### PRIORITY DATA

The present patent application is a 371 of International Application Ser. No. PCT/US11/40748 filed 16 Jun. 2011, which claims benefit from Ser. No. 61/356,083 filed 18 Jun. 2010, now expired, and Ser. No. 61/478,185 filed 22 Apr. 2011, now expired. The applications listed above are incorporated by reference from as if entirely restated herein.

### BACKGROUND OF THE INVENTION

The present invention relates to chewing gum. More specifically, this invention relates to improved formulations for chewing gum products containing ethyl ester of N-[[5-methyl-2-(1-methylethyl)-cyclohexyl]carbonyl]glycine, commonly known as WS-5. More particularly, the invention relates to producing chewing gum containing WS-5 as a physiological cooling agent.

Many individuals who chew chewing gum desire that the gum have a refreshing taste, and most typically this includes a cooling sensation. Peppermint oil is frequently used to create a “cooling” in oral products such as toothpaste, mouthwash, chewing gum, candy and other food products. Peppermint oil generally comprises about 45% menthol, about 20% menthone, about 5% menthyl acetate, about 5% eucalyptol and many other constituents. Peppermint oil is even used in non-peppermint products, such as spearmint or wintergreen flavored products, in order to create this desired cooling effect. However, peppermint notes are then found in the resulting non-peppermint flavored products.

Menthol is also known for its physiological cooling effect on the skin and mucous membranes of the mouth. Being a major constituent of peppermint oil, menthol has been used extensively in foods, beverages, dentifrices, mouthwashes, toiletries, lotions and the like. The disadvantages of using menthol, however, are its strong minty odor and the harsh notes it imparts to compositions in which it is found.

Several known compounds have what can be characterized as a “cooling” activity, and are referred to in the art as “physiological cooling agents.” Physiological cooling agents are perceived as cold or cool when contacted with the human body and, in particular, with the mucous membranes of the mouth, nose and throat. Several of these compounds have been suggested for use in confectionery products, including chewing gum.

However, while these physiological cooling agents are less objectionable than menthol, when they are used at high levels to provide desirable refreshing coolness, they also have objectionable flavor characteristics, such as bitterness, biting and sharpness along with off tastes.

It would be desirable to provide a chewing gum with a high level of refreshing taste with a cooling sensation and desirable breath freshening, but without using materials that manifest the unwanted harshness or flavor characteristics that come from adding menthol. It would also be desirable to provide a clean, high-quality flavor chewing gum with a good cooling and breath freshening effect.

### SUMMARY OF THE INVENTION

Chewing gum compositions have been invented that provide a high level of refreshing taste with significant breath freshening without objectionable flavor characteristics. In a first aspect, the invention is a chewing gum composition comprising gum base, flavor, sweetening agent, and about 0.3% to about 0.6% WS-5.

In a second aspect, the invention is a chewing gum product comprising a gum composition made from gum base, flavor, and sweetening agent, and wherein the gum product includes about 0.3% to about 0.6% ethyl ester of N-[[5-methyl-2-(1-methylethyl)-cyclohexyl]carbonyl]glycine (WS-5) by weight of the gum product.

In a third aspect, the invention includes a chewing gum composition which comprises gum base, flavor, at least one sweetening agent selected from the group consisting of sugars, sugar alcohols, and mixtures thereof, and a cooling agent other than WS-5 in a amount to impart cooling to said gum at a level in the range found in typical commercial gum products, the improvement comprising adding about 0.3% to about 0.6% WS-5 by weight of the total gum composition whereby the cooling and breath freshening are enhanced.

In a fourth aspect, the invention includes a chewing gum composition comprising about 5% to about 95% gum base, about 0.1% to about 10% flavor, about 10% to about 90% sweetening agent selected from the group consisting of sugars, sugar alcohols, and mixtures thereof, and WS-5 present in an amount sufficient to provide the gum with a combination of good cooling properties and breath freshening properties without bitterness.

The use of WS-5 at levels of about 0.3% to about 0.6% has been surprisingly found to provide a gum composition and gum products that have high levels of refreshing taste with considerable cooling and breath freshening but without unwanted flavor characteristics. The WS-5 physiological cooling agent may be used in combination with other physiological cooling agents, and it may be treated to control its release and enhance its shelf life stability. Also, the WS-5 physiological cooling agent may be added as part of a cooling flavor composition, or used in a chewing gum coating. Additional features and advantages of the disclosed embodiments are described in, and will be apparent from, the following Detailed Description and the attached drawings.

### BRIEF DESCRIPTION OF THE DRAWINGS

FIG. 1 is a graphical illustration of the cooling intensity, after 20 minutes of chewing, of a chewing gum of the present invention compared to chewing gum compositions using lower levels of WS-5 and chewing gum compositions containing other physiological cooling agents.

FIG. 2 is a graphic illustration of breath freshening liking, after 20 minutes of chewing, of a chewing gum of the present invention compared to chewing gum compositions using lower levels of WS-5 and chewing gum compositions containing other physiological cooling agents.

FIG. 3 is a graphic illustration of breath freshening effectiveness, after 20 minutes of chewing, of a chewing gum of the present invention compared to chewing gum compositions using lower levels of WS-5 and chewing gum compositions containing other physiological cooling agents.

FIG. 4 is a graphic illustration of breath freshening lastingness, after 20 minutes of chewing, of a chewing gum of the present invention compared to chewing gum compositions using lower levels of WS-5 and chewing gum compositions containing other physiological cooling agents.

### DETAILED DESCRIPTION

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Unless otherwise specified, all percentages herein are weight percentages. Although some terms are referred to in the singular, it is understood that such references may also encompass the plural. For example, although chewing gum coating is referred to in the singular, it is understood that coated chewing gum normally contains multiple layers of coating. Therefore a phrase that refers to “the coating,” refers to one or more layers of coating. Finally, all references cited herein are incorporated by reference.

Several terms used in the specification and claims have a meaning defined as follows.

In the context of this invention, chewing gum refers to chewing gum, bubble gum and the like.

The breath freshening discussed herein is consumer perceived breath freshening, rather than objectively measured breath freshening.

Physiological cooling agents encompass any number of physiological cooling agents. However, in the context of this invention, the term “physiological cooling agent” does not include traditional flavor-derivatives such as menthol or menthone. Preferred physiological cooling agents do not have a perceptible flavor of their own, but simply provide a cooling effect.

The term “WS-5” refers to ethyl ester of N-[[5-methyl-2-(1-methylethyl)-cyclohexyl]carbonyl]glycine, also called [(Ethoxycarbonyl)methyl]-p-menthane-3-carboxamide, designated by FEMA as No. 4309. It is recognized that some commercially available compositions sold as WS-5 may not be pure ethyl ester of N-[[5-methyl-2-(1-methylethyl)-cyclohexyl]carbonyl]glycine, but may contain small percentages of impurities that are byproducts of manufacture. Preferably the WS-5 used in the gum compositions of the present invention will have a purity of at least 96% ethyl ester of N-[[5-methyl-2-(1-methylethyl)-cyclohexyl]carbonyl]glycine, as described in U.S. Pat. No. 7,189,760. In the present application, WS-5 means 100% pure ethyl ester of N-[[5-methyl-2-(1-methylethyl)-cyclohexyl]carbonyl]glycine. If an impure mixture is used, usage levels may need to be adjusted to take the purity level into account.

Particular examples of physiological cooling agents that may be used along with WS-5 in chewing gums of the present invention include:
1) substituted p menthanes and substituted p-menthane-carboxamides, such as those disclosed in U.S. Pat. Nos. 4,060,091; 4,190,643 and 4,136,163, all assigned to Wilkinson Sword;
2) acyclic carboxamides, such as those disclosed in U.S. Pat. Nos. 4,296,255; 4,230,688; and 4,153,679; all assigned to Wilkinson Sword, especially N-ethyl-p-menthane-3-carboxamide (WS-3, FEMA 3455));
3) acyclic carboxamides (e.g., N,2,3-trimethyl-2-isopropyl butanamide (WS-23, FEMA 3804));
4) Other compounds from Wilkinson Sword, including substituted cyclohexanamides, substituted cyclohexane carboxamides, substituted ureas and sulphonamides, and substituted menthanols;
5) hydroxymethyl and hydroxyethyl derivatives of p-menthane;
6) menthyl succinate (FEMA 3810);
7) 2-mercapto-cyclo-decanone;
8) 2-isopropanyl-5-methylcyclohexanol (hereinafter “isopulegol”, FEMA 2962);
9) hydroxycarboxylic acids with 2-6 carbon atoms;
10) menthone glycerol ketals (FEMA 3807);
11) menthol propylene glycol carbonate (FEMA 3806);
12) menthol ethylene glycol carbonate (FEMA 3805);
13) 3-l-menthoxypropane-1,2-diol (FEMA 3784);
14) menthyl lactate; (FEMA 3748); and
15) monomenthyl glutarate (FEMA 4006).

While any of the above-disclosed physiological cooling agents may be included in chewing gum, the physiological cooling agents that are presently preferred to be included with the WS-5 are menthyl succinate; menthyl lactate; 3-l-menthoxypropane-1,2-diol; N-substituted p-menthane carboxamides; acyclic carboxamides; menthone glycerol ketals, menthyl glutarate, l-isopulegol and mixtures thereof. The concentration of physiological cooling agent will depend on the intensity of the physiological cooling agent and the desired cooling effect. The additional physiological cooling agent, when used, will preferably be present at about 0.01% to about 0.5% of the chewing gum product, preferably with no one of the additional physiological cooling agents comprising more that about 0.4% of the gum product. Depending on the level of WS-5 that is used, the level of the other physiological cooling agents (when used) may be between about 0.05% and about 0.4%, or even between about 0.1% and about 0.3% of the chewing gum product.

The present invention contemplates that WS-5 and optional additional physiological cooling agents may be added to the flavor used to make the chewing gum. On the other hand, the flavor and cooling agents may be added separately anywhere within the manufacturing process for making a chewing gum. In addition, physiological cooling agents including WS-5 may be encapsulated to modify their release rate from chewing gum.

These flavors include any flavor which is of food acceptable quality commonly known in the art such as essential oils, synthetic flavors or mixtures thereof. Such flavors include, but are not limited to, oils derived from plants and fruits such as citrus oils, fruit essences, peppermint oil, spearmint oil, eucalyptus, other mint oils, clove oil, oil of wintergreen, cinnamic aldehyde, anise, spice flavors, and the like. Flavors that are very strong, such as menthol flavors, are also contemplated in this invention. Preferred flavors include cooling flavors such as peppermint, eucalyptus, menthol, wintergreen and fruity-mint; non-cooling flavors such as spearmint and cinnamon; and combinations thereof. In some embodiments, the chewing gum products will include menthol, and may include about 0.01% to about 2.0% menthol, preferably less than 0.5%.

Artificial flavor components are also contemplated by the present invention. Those of ordinary skill in the art will recognize that natural and artificial flavors may be combined in any sensorially acceptable blend. All such flavors and blends are contemplated by the present invention.

The flavor may be added to the chewing gum formula in an amount such that it will contain from about 0.1% to about 10% flavor, preferably from about 0.2% to about 4.0% flavor, and most preferably about 0.5% to about 2% flavor.

Physiological cooling agents in a liquid form may be added directly to a chewing gum formulation in its liquid form or may be combined with flavors or with other solvents such as alcohol, glycerin, propylene glycol, flavor solvents, emulsifiers, or vegetable oils. Physiological cooling agents in crystalline or powder form may also be added directly to a chewing gum formulation in its powder form or may be combined with other powdered bulking agents such as sugars, polyols, and other types of powdered ingredients. In some cases physiological cooling agents may be emulsified in flavor/water compositions or oil/water compositions. Most importantly, because of the low level of usage, the physiological cooling agents need to be evenly dispersed throughout the chewing gum composition.

In most instances, liquid physiological cooling agents may be combined and readily added directly to a gum or confectionery formulation. In other instances, crystalline or powder physiological cooling agents as well as menthol may be dissolved in other liquid physiological cooling agents and the combinations readily added directly to a gum or confectionery formulation. It is also known that some crystalline physiological cooling agents as well as menthol may be combined to form eutectic mixtures which have a lower melting point than the individual crystalline cooling agents themselves. As a result, mixtures of some crystalline physiological cooling agents can be melted, blended together, and remain liquid at or near room temperature and can then be added directly to a chewing gum or confectionery formulation. Combinations of menthol with physiological cooling agents such as menthyl lactate, menthyl succinate, p-menthane carboxamides like WS-3, acyclic carboxamides like WS-23, can be melted together and used readily in liquid form in product formulations.

The WS-5 may be used in sugarless gum formulations and may also be used in a sugar chewing gum. The WS-5 may be used in either regular chewing gum or bubble gum.

The chewing gum composition of the present invention follows the general pattern outlined below. In general, a chewing gum composition typically contain a chewable gum base portion which is essentially free of water and is water-insoluble, a water-soluble bulk portion and flavors which are typically water insoluble. The water-soluble portion dissipates with a portion of the flavor over a period of time during chewing. The gum base portion is retained in the mouth throughout the chew.

The insoluble gum base generally comprises elastomers, elastomer solvents, plasticizers, waxes, emulsifiers and inorganic fillers. Plastic polymers, such as polyvinyl acetate, which behave somewhat as plasticizers, are also often included. Other plastic polymers that may be used include polyvinyl laureate, polyvinyl alcohol and polyvinyl pyrrolidone.

Elastomers may include polyisobutylene, butyl rubber, (isobutylene-isoprene copolymer) and styrene butadiene rubber, as well as natural latexes such as chicle. Elastomer solvents are often resins such as terpene resins. Plasticizers, sometimes called softeners, are typically fats and oils, including tallow, hydrogenated and partially hydrogenated vegetable oils, and cocoa butter. Commonly employed waxes include paraffin, microcrystalline and natural waxes such as beeswax and carnauba. Microcrystalline waxes, especially those with a high degree of crystallinity, may be considered bodying agents or textural modifiers.

According to the preferred embodiment of the present invention, the insoluble gum base constitutes between about 5% to about 95% by weight of the gum. More preferably the insoluble gum base comprises between 10% and 50% by weight of the gum and most preferably about 20% to 35% by weight of the gum.

The gum base typically also includes a filler component. The filler component may be calcium carbonate, magnesium carbonate, talc, dicalcium phosphate or the like. The filler may constitute between about 5% and about 60% by weight of the gum base. Preferably the filler comprises about 5% to 50% by weight of the gum base.

Gum bases typically also contain softeners including glycerol monostearate and glycerol triacetate. Gum bases may also contain optional ingredients such as antioxidants, colors, and emulsifiers. The present invention contemplates employing any commercially acceptable gum base.

The water-soluble portion of the chewing gum may further comprise softeners, sweeteners, flavors, physiological cooling agents and combinations thereof. The sweeteners often fulfill the role of bulking agents in the gum. The bulking agents typically comprise about 5% to about 95% of the gum composition.

Softeners are added to the chewing gum in order to optimize the chewability and mouth feel of the gum. Softeners, also known in the art as plasticizers or plasticizing agents, generally constitute between about 0.5% to about 15% of the chewing gum. Softeners contemplated by the present invention include glycerin, lecithin and combinations thereof. Further, aqueous sweetener solutions such as those containing sorbitol, hydrogenated starch hydrolysate, corn syrup and combinations thereof may be used as softeners and binding agents in gum.

As mentioned above, the WS-5 and optional additional physiological cooling agents of the present invention may be used in sugarless gum formulations. However, formulations containing sugar are also within the scope of the invention. Sugar sweeteners generally include saccharide-containing components commonly known in the chewing gum art which comprise, but are not limited to, sucrose, dextrose, maltose, dextrin, dried invert sugar, fructose, galactose, corn syrup solids and the like, alone or in any combination.

The WS-5 and optional additional physiological cooling agents of the present invention can also be used in combination with sugarless sweeteners. Generally sugarless sweeteners include components with sweetening characteristics but which are devoid of the commonly known sugars and comprise, but are not limited to, sugar alcohols such as sorbitol, hydrogenated isomaltulose, mannitol, xylitol, lactitol, erythritol, hydrogenated starch hydrolysate, maltitol and the like alone or in any combination

Depending on the particular sweetness release profile and shelf-stability needed, coated or uncoated high-intensity sweeteners may be used in the chewing gum composition, or may be used in a coating applied to centers made from those gum compositions. High-intensity sweeteners, preferably aspartame, may be used at levels from about 0.01% to about 3.0%. Encapsulated aspartame is a high intensity sweetener with improved stability and release characteristics, as compared to free aspartame. Free aspartame can also be added, and a combination of some free and encapsulated aspartame is preferred when aspartame is used. Other high intensity sweeteners that may be used in the gum center are: saccharin, Thaumatin, alitame, saccharin salts, sucralose, Stevia, and acesulfame K. Overall, the chewing gum composition will preferable comprise about 0.5% to about 90% sweetening agents. Most typically the sweetening agents will comprises at least one bulk sweetener and at least one high-intensity sweetener.

Optional ingredients such as colors, emulsifiers and pharmaceutical agents may also be added as separate components of the chewing gum composition, or added as part of the gum base.

Aqueous syrups, such as corn syrup and hydrogenated corn syrup may be used, particularly if their moisture content is reduced. This can preferably be done by coevaporating the aqueous syrup with a plasticizer, such as glycerin or propylene glycol, to a moisture content of less than 10%. Preferred compositions include hydrogenated starch hydrolysate solids and glycerin. Such syrups and their methods of preparation are discussed in detail in U.S. Pat. No. 4,671,967.

A preferred method of manufacturing chewing gum according to the present invention is by sequentially adding the various chewing gum ingredients to any commercially available mixer known in the art. After the ingredients have been thoroughly mixed, the gum is discharged from the mixer and shaped into the desired form such as by rolling into sheets and cutting into sticks, extruding into chunks, or casting into pellets.

Generally, the ingredients are mixed by first melting the gum base and adding it to the running mixer. The base may also be melted in the mixer itself. Color or emulsifiers may also be added at this time, along with syrup and a portion of the bulking agent. Further portions of the bulking agent may then be added to the mixer. A flavoring agent is typically added with the final portion of the bulking agent. The WS-5 physiological cooling agent may be mixed with the flavor composition of the present invention and preferably added as part of the flavor addition. If the WS-5 is coated to modify its release rate, it will preferably be added after the final portion of bulking agent and flavor has been added. The entire mixing procedure typically takes from five to twenty minutes, but longer mixing times may sometime be required. Those skilled in the art will recognize that many variations of the above described procedures may be followed.

If formed into pellets or balls, the chewing gum composition can be coated. The coating is initially present as a liquid syrup which contains from about 30% to about 80% or 85% sugars or sugar alcohols, and from about 15% or 20% to about 70% of a solvent such as water. In general, the coating process is carried out in conventional panning equipment. Gum center tablets to be coated are placed into the panning equipment to form a moving mass.

The material or syrup which will eventually form the coating is applied or distributed over the gum center tablets. Flavors may be added before, during and after applying the syrup to the gum centers. Once the coating has dried to form a hard surface, additional syrup additions can be made to produce a plurality of coatings or multiple layers of coating.

In the panning procedure, syrup is added to the gum center tablets at a temperature range of from about 100° F. to about 240° F. Preferably, the syrup temperature is from about 140° F. to about 200° F. Most preferably, the syrup temperature should be kept constant throughout the process in order to prevent the polyol in the syrup from crystallizing. The syrup may be mixed with, sprayed upon, poured over, or added to the gum center tablets in any way known to those skilled in the art.

In another embodiment, a soft coating is formed by adding a powder coating after a liquid coating. The powder coating may include natural carbohydrate gum hydrolysates, maltodextrin, gelatin, cellulose derivatives, starches, modified starches, sugars, sugar alcohols, natural carbohydrate gums and fillers like talc and calcium carbonate.

Each component of the coating on the gum center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the gum center tablet. Preferably, no more than about 75 coats are applied to the gum center. More preferably, less than about 60 coats are applied and most preferably, about 30 to about 60 coats are applied. In any event, the present invention contemplates applying an amount of syrup sufficient to yield a coated chewing gum product containing about 10% to about 65% coating. Preferably, the final product will contain from about 20% to about 50% coating.

Those skilled in the art will recognize that in order to obtain a plurality of coated layers, a plurality of premeasured aliquots of coating syrup may be applied to the gum center. It is contemplated, however, that the volume of aliquots of syrup applied to the gum center may vary throughout the coating procedure.

Once a coating of syrup is applied to the gum center, the syrup is dried in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possesses a relative humidity of less than about 15 percent. Preferably, the relative humidity of the drying air is less than about 8 percent.

The drying air may be passed over and admixed with the syrup coated gum centers in any way commonly known in the art. Preferably, the drying air is blown over and around the syrup coated gum center at a flow rate, for large scale operations, of about 2800 cubic feet per minute. If lower quantities of material are being processed, or if smaller equipment is used, lower flow rates would be used. If a flavor is applied after a syrup coating has been dried, the present invention contemplates drying the flavor with or without the use of a drying medium.

### Examples

The following examples of the invention and comparative formulations are provided to illustrate, but not to limit, the invention which is defined by the attached claims. Amounts listed are in weight percent.

Several chewing gum compositions were made with WS-5, and their compositions are provided in Table 1 below.

TABLE 1

| | Comparative | Comparative | | | Comparative | Comparative |
|---|---|---|---|---|---|---|
| | Example A | Example B | Example 1 | Example 2 | Example C | Example D |
| Sugarless syrup** | 35.73% | 35.63% | 35.43% | 36.38% | 36.38% | 36.38% |
| Sorbitol | 31.55% | 31.55% | 31.55% | 34.13% | 33.73% | 33.33% |
| Gum base | 25.90% | 25.90% | 25.90% | 25.90% | 25.90% | 25.90% |
| Peppermint flavor* | 2.12% | 2.12% | 2.12% | 1.95% | 1.95% | 1.95% |
| WS-5* | 0.10% | 0.20% | 0.40% | 0.60% | 1.00% | 1.40% |
| Menthol* | 0.20% | 0.20% | 0.20% | 0.20% | 0.20% | 0.20% |
| Encapsulated menthol | 0.20% | 0.20% | 0.20% | | | |
| Encapsulated peppermint | 0.25% | 0.25% | 0.25% | | | |
| flavor | | | | | | |
| Encapsulated high intensity | 2.90% | 2.90% | 2.90% | 0.40% | 0.40% | 0.40% |
| sweeteners | | | | | | |
| Free high intensity | 0.10% | 0.10% | 0.10% | 0.44% | 0.44% | 0.44% |
| sweeteners | | | | | | |
| Glycerin | 0.80% | 0.80% | 0.80% | | | |
| 10% Salt solution | 0.05% | 0.05% | 0.05% | | | |
| Color | 0.10% | 0.10% | 0.10% | | | |
| Total | 100.00% | 100.00% | 100.00% | 100.00% | 100.00% | 100.00% |

*Menthol and coolant were dissolved in this peppermint flavor before adding to gum.
**Coevaporated aqueous mixture of sorbitol, mannitol, maltitol, and glycerin.
The peppermint flavor used in Examples A, B and 1 also contained 11% other physiological cooling agents (or about 0.23% of the gum), namely a combination of menthyl glutarate, I-isopulegol, and menthyl succinate.

Samples of Example 2, Comparative Example C and Comparative Example D were evaluated by a group of ten panelist, who were given a sensory questionnaire in which they were asked to rate the samples in three characteristics: bitterness, cooling and breath freshening. They each chewed the samples for 12 minutes, and were asked to rate the sample at the highest point for the rated characteristic reached in that 12 minutes. The results are shown in Table 2.

TABLE 2

| | | Bitterness at highest point during | | |
|---|---|---|---|---|
| | | 12 minute chew, number of responses | | |
| | | Low-None | Acceptable | Too High |
| 0.6% WS-5 | Example 2 | 2 | 5 | 3 |
| 1.0% WS-5 | Comp. Ex. C | 1 | 3 | 6 |
| 1.4% WS-5 | Comp. Ex. D | 1 | 2 | 7 |
| | | Cooling at highest point during | | |
| | | 12 minute chew, number of responses | | |
| | | Too | | |
| | | Low-None | Acceptable | Too High |
| 0.6% WS-5 | Example 2 | 0 | 7 | 3 |
| 1.0% WS-5 | Comp. Ex. C | 0 | 6 | 4 |
| 1.4% WS-5 | Comp. Ex. D | 0 | 3 | 7 |

| | | Breath Freshening at highest point during | | |
|---|---|---|---|---|
| | | 12 minute chew, number of responses | | |
| | | Too | | |
| | | Low-None | Average | Excellent |
| 0.6% WS-5 | Example 2 | 0 | 3 | 7 |
| 1.0% WS-5 | Comp. Ex. C | 0 | 6 | 4 |
| 1.4% WS-5 | Comp. Ex. D | 0 | 6 | 4 |

The sample containing 0.6% WS-5 gave good cooling and good breath freshening with low bitterness. At levels of 1.0% WS-5 and 1.4% WS-5, cooling increased, but so did bitterness. Surprisingly, breath freshening did not increase, but actually became less at levels above 0.6%. Based on these tests, to provide quality flavor characteristics in chewing gum a maximum use level for WS-5 is about 0.6%. Levels above 0.6% show that WS-5 appears to have some negative properties that reduces this coolant's acceptability for coolness and breath freshening properties. In other testing, discussed below, the use of WS-5 at levels above about 0.3% provides surprising results. It is thus surprising that at levels of between about 0.3% to about 0.6% WS-5, and especially at levels between about 0.4% and about 0.6%, a chewing gum has a combination of good cooling properties and breath freshening properties without bitterness. In some cases the WS-5 will comprise no more than 0.5% of the gum composition. In some cases the composition will comprises at least 0.4% WS-5. Thus the WS-5 may be present in levels of about 0.3% to about 0.5%, about 0.4% to about 0.6%, about 0.4% to about 0.5% and about 0.3% to about 0.4% of the gum composition.

Chewing gum products including WS-5 may be made that have components other than a single chewing gum composition. In those cases, the level of WS-5 should be based on the weight of the product, rather than just the composition. For example, a chewing gum composition with 0.8% WS-5 in the composition could be formed into a pellet and then coated. If the coating comprises 33% of the total product weight, then the WS-5 would comprise 0.53% of the chewing gum product. In such products, the WS-5 may be in other parts of the product besides or in addition to the chewing gum composition. For example, WS-5 may be included in the centerfill of a liquid center chewing gum product, or a multilayer gum product could be made with WS-5 in the compositions used to make one or more of the layers. In these products, the gum product will include about 0.3% to about 0.6% WS-5 by weight of the gum product. In some cases the WS-5 will comprise no more than 0.5% by weight of the gum product. In some cases the product comprises at least 0.4% WS-5 by weight of the gum product. Thus the WS-5 may be present in levels of about 0.3% to about 0.5%, about 0.4% to about 0.6%, about 0.4% to about 0.5% and about 0.3% to about 0.4% by weight of the gum product.

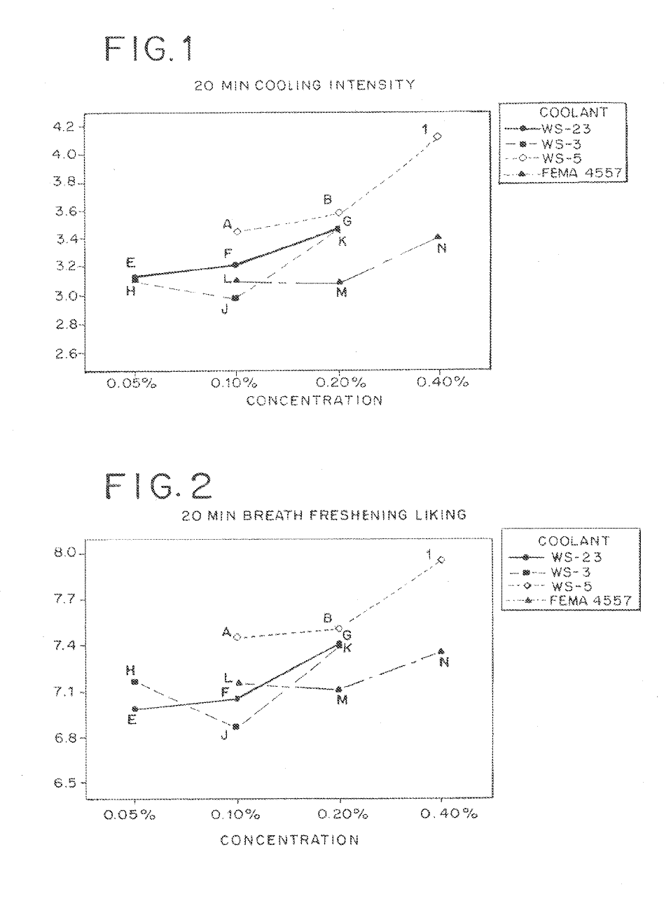

FIGS. 1-4 show test results of consumer preference testing of compositions that contained WS-5 and three other physiological cooling agents, namely WS-23, WS-3 and an acyclic carboxamide physiological cooling agent known by its FEMA designation 4557: N,2-diethyl-3-methyl-2-isopropyl butanamide. The formulas for the compositions tested are given in for Comparative Examples A and B, and Example 1 in Table 1 above, and for the other comparative samples in Table 3 below

TABLE 3

| | Comparative | Comparative | Comparative | Comparative | Comparative | Comparative |
|---|---|---|---|---|---|---|
| | Sample E | Sample F | Sample G | Sample H | Sample J | Sample K |
| Sugarless syrup** | 35.78% | 35.73% | 35.63% | 35.78% | 35.73% | 35.63% |
| Sorbitol | 31.55% | 31.55% | 31.55% | 31.55% | 31.55% | 31.55% |
| Gum base | 25.90% | 25.90% | 25.90% | 25.90% | 25.90% | 25.90% |
| Peppermint flavor* | 2.12% | 2.12% | 2.12% | 2.12% | 2.12% | 2.12% |
| WS-3* | | | | 0.05% | 0.10% | 0.20% |
| WS-23* | 0.05% | 0.10% | 0.20% | | | |
| Menthol* | 0.20% | 0.20% | 0.20% | 0.20% | 0.20% | 0.20% |
| Encapsulated menthol | 0.20% | 0.20% | 0.20% | 0.20% | 0.20% | 0.20% |
| Encapsulated peppermint flavor | 0.25% | 0.25% | 0.25% | 0.25% | 0.25% | 0.25% |
| Encapsulated high intensity | 2.90% | 2.90% | 2.90% | 2.90% | 2.90% | 2.90% |
| sweeteners | | | | | | |
| Free high intensity sweeteners | 0.10% | 0.10% | 0.10% | 0.10% | 0.10% | 0.10% |
| Glycerin | 0.80% | 0.80% | 0.80% | 0.80% | 0.80% | 0.80% |
| 10% Salt solution | 0.05% | 0.05% | 0.05% | 0.05% | 0.05% | 0.05% |
| Color | 0.10% | 0.10% | 0.10% | 0.10% | 0.10% | 0.10% |
| Total | 100.00% | 100.00% | 100.00% | 100.00% | 100.00% | 100.00% |

| | Comparative | Comparative | Comparative |
|---|---|---|---|
| | Sample L | Sample M | Sample N |
| Sugarless syrup** | 35.73% | 35.63% | 35.43% |
| Sorbitol | 31.55% | 31.55% | 31.55% |
| Gum base | 25.90% | 25.90% | 25.90% |
| Peppermint flavor* | 2.12% | 2.12% | 2.12% |
| FEMA 4557 (N,2-diethyl-3-methyl-2-isopropyl | 0.10% | 0.20% | 0.40% |
| butanamide) | | | |
| Menthol* | 0.20% | 0.20% | 0.20% |
| Encapsulated menthol | 0.20% | 0.20% | 0.20% |
| Encapsulated peppermint flavor | 0.25% | 0.25% | 0.25% |
| Encapsulated high intensity sweeteners | 2.90% | 2.90% | 2.90% |
| Free high intensity sweeteners | 0.10% | 0.10% | 0.10% |
| Glycerin | 0.80% | 0.80% | 0.80% |
| 10% Salt solution | 0.05% | 0.05% | 0.05% |
| Color | 0.10% | 0.10% | 0.10% |
| Total | 100.00% | 100.00% | 100.00% |

*Menthol and coolant were dissolved in this peppermint flavor before adding to gum.
**Coevaporated aqueous mixture of sorbitol, mannitol, maltitol, and glycerin.
The peppermint flavor used in Examples A, B and 1 also contained 11% other physiological cooling agents (or about 0.23% of the gum), namely a combination of menthyl glutarate, I-isopulegol, and menthyl succinate.

The compositions were made into stick gum products and given to individuals to chew and rate the products in several categories. The test methodology was as follows:
a) An incomplete block design test was used: 120 consumers, each consumer chews 8 of the 12 samples such that there are 80 observations for each sample;
b) Test conducted with 20 min chew time, with 10 minutes between chews;
c) Consumers evaluated 1 stick of product per sample;
d) Time intervals for sensory measurement were at: 1, 3, 6, 9, 12 and 20 minutes.

FIG. 1 shows the result for consumer preference ratings for cooling intensity at 20 minutes of chewing. The Example letters and number, and Sample letters, are provided for individual data points on the graph. It can be seen that samples made with WS-5 at 0.1% and 0.2% had generally higher 20 minute cooling intensity ratings than the samples made with WS-23, WS-3, and FEMA 4557. However, Example 1, with 0.4% WS-5, was surprisingly rated significantly higher in cooling intensity than the other samples and even the Examples A and B that also contained WS-5 but at lower levels.

FIG. 2 shows the result for consumer preference ratings for breath freshening liking at 20 minutes of chewing. Just as with FIG. 1, the Example letters and number, and Sample letters, are provided for individual data points on the graph. It can be seen that samples made with WS-5 at 0.1% and 0.2% had generally higher 20 minute breath freshening liking ratings than the samples made with WS-23, WS-3 and FEMA 4557. However, Example 1, with 0.4% WS-5, was surprisingly rated significantly higher in breath freshening liking than the other samples and even the Examples A and B that also contained WS-5 but at lower levels.

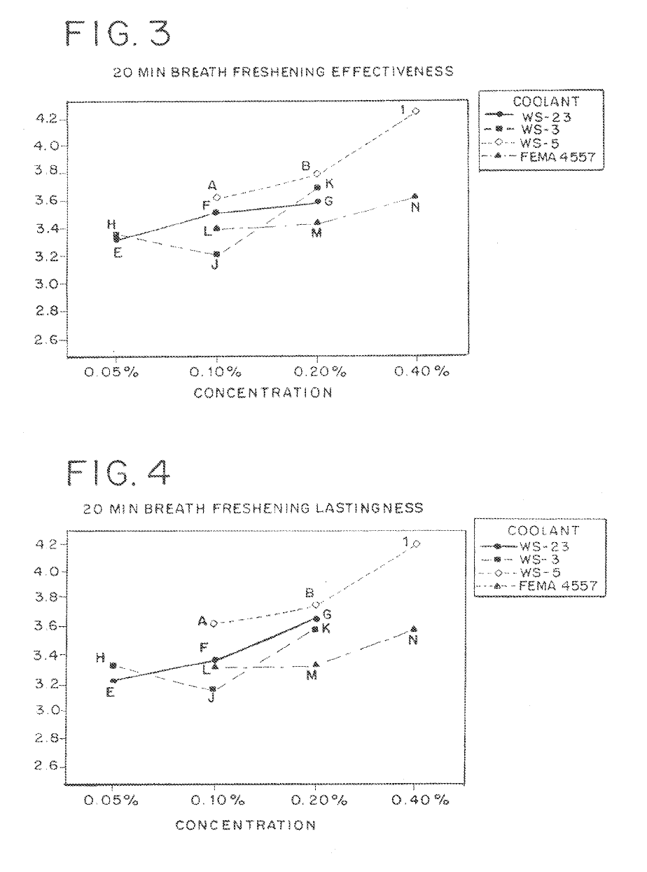

FIG. 3 shows the result for consumer preference ratings for breath freshening effectiveness at 20 minutes of chewing. Just as with FIGS. 1 and 2, the Example letters and number, and Sample letters, are provided for individual data points on the graph. It can be seen that samples made with WS-5 at 0.1% and 0.2% had generally higher 20 minute breath freshening effectiveness ratings than the samples made with WS-23, WS-3 and FEMA 4557. However, Example 1, with 0.4% WS-5, was surprisingly rated significantly higher in breath freshening effectiveness than the other samples and even the Examples A and B that also contained WS-5 but at lower levels.

FIG. 4 shows the result for consumer preference ratings for breath freshening lastingness at 20 minutes of chewing. Just as with FIGS. 1, 2 and 3, the Example letters and number, and Sample letters, are provided for individual data points on the graph. It can be seen that samples made with WS-5 at 0.1% and 0.2% had generally higher 20 minute breath freshening lastingness ratings than the samples made with WS-23, WS-3 and FEMA 4557. However, Example 1, with 0.4% WS-5 was surprisingly rated significantly higher in breath freshening lastingness than the other samples and even the Examples A and B that also contained WS-5 but at lower levels.

In the consumer test, ratings were also taken at 1, 3, 6, 9, 12, and 20 minutes for cooling intensity, cooling liking, flavor intensity, and flavor liking. In general, all of the ratings were higher at higher levels of any one particular coolant. WS-5 had overall higher ratings at each time interval than any other coolant. However, ratings for breath freshening liking, breath freshening effectiveness, and breath freshening lastingness were only measured at the 20 minute time interval.

With coolants like WS-3, WS-23 and 4557, an increase in the usage level of a coolant shows an increase in coolant intensity, but that cooling increase does not increase at as great of a rate as the increase in the concentration of the coolant. Also, other negative characteristics of the coolant lower the overall acceptance and breath freshening benefits of the coolant at higher levels as the level increases. However, with WS-5, the increased level above about 0.3% showed that WS-5 had significantly more benefits in cooling and breath freshening attributes than would be expected and as was found with the other coolants. For example, coolant 4557 did not show significant cooling or breath freshening benefits at levels above 0.3% compared to WS-5. At a level of 0.2%, WS-5 showed only expected or lower than expected breath freshening and cooling benefits, comparable to products that contain WS-3 or WS-23. But in the 0.4% to 0.6% range, the breath freshening and cooling benefits were significantly enhanced. It is believed that that these enhanced benefits will be applicable to gum products that contain at least 0.3% WS-5.

As can be seen in the earlier tests of Example 2 and Comparative Examples C and D, the higher levels of WS-5 above 0.6% had other negative characteristics that reduced the overall acceptance of the WS-5 coolant at these higher levels.

The use of 0.3% to 0.6% of WS-5 by weight of the chewing gum product also provides surprising results compared to usage levels that would be used based on usage levels of WS-3. U.S. Pat. No. 7,189,760 states that WS-5 is approximately 3 times stronger than WS-3 in aqueous solutions when it comes to providing a stronger and longer lasting cooling effect Normally commercial gum products are not formulated with WS-3 levels higher than about 0.5%. Therefore it would be expected that the proper usage level for WS-5 in gum would not be greater than about 0.17% (⅓ of 0.5%). However, as discussed above, it has surprisingly been found that the WS-5 needs to be used in gum at a level of greater than 0.3% to provide superior cooling and breath freshening effects. What is further surprising is that a gum product with superior breath freshening properties can be made with WS-5 levels of 0.5% and even 0.6%. A gum product made with 1.5% or 1.8% WS-3 would not have the superior properties found with chewing gum products of the present invention.

Other chewing gum composition examples of the present invention may be made as described in Table 4 below.

TABLE 4

| | Example | Example | Example | Example | Example | Example | Example |
|---|---|---|---|---|---|---|---|
| | 3 | 4 | 5 | 6 | 7 | 8 | 9 |
| Sorbitol | 48.00 | 48.00 | 48.00 | 48.00 | 48.00 | 48.40 | 48.00 |
| Gum Base | 34.05 | 34.05 | 34.05 | 34.05 | 34.10 | 35.00 | 34.05 |
| 70% Sorbitol Solution | 10.00 | 10.00 | 10.00 | 10.00 | 10.00 | 8.00 | 10.00 |
| Glycerin | 5.00 | 5.00 | 5.00 | 5.00 | 5.00 | 6.00 | 5.00 |
| Encapsulated | 0.30 | 0.30 | 0.30 | 0.30 | 0.30 | 0.50 | 0.30 |
| Aspartame | | | | | | | |
| Methyl Salicylate | 0.50 | 0.50 | 0.50 | 0.50 | 0.70 | 0.80 | 0.50 |
| Peppermint Oil | 1.30 | 1.30 | 1.30 | 1.30 | 1.00 | 0.40 | 1.30 |
| Spearmint Oil | 0.20 | 0.20 | 0.20 | 0.20 | 0.10 | | 0.20 |
| WS-5 | 0.30 | 0.30 | 0.30 | 0.30 | 0.30 | 0.50 | 0.30 |
| Menthane Glycerol | 0.05 | | | | | 0.10 | |
| Ketal | | | | | | | |
| Menthyl Glutarate | 0.30 | | | | | | |
| Menthyl Succinate | | | | | 0.30 | | |
| Isopulegol | | 0.30 | 0.30 | 0.30 | | | |
| Menthyl Aceto Acetate | | 0.05 | | | | | |
| Menthol | | | | | | 0.20 | |
| MHB | | | 0.05 | | | | |
| MPGC | | | | 0.05 | | | |
| WS-3 | | | | | 0.20 | | |
| EDIB | | | | | | 0.10 | |
| Menthyl Lactate | | | | | | | 0.30 |
| TCA | | | | | | | 0.05 |
| | 100.00 | 100.00 | 100.00 | 100.00 | 100.00 | 100.00 | 100.00 |

MHB = Menthyl-3-hydroxybutyrate (FEMA 4308)
MPGC = Menthol propylene glycol carbonate (FEMA 3806)
EDIB = N-(2-ethoxyethyl)-2,3-dimethyl-2-isopropyl butanamide
TCA = 3-I-menthoxypropane-1,2-diol

The chewing gum compositions of Table 4 have a cooling agent other than WS-5 in an amount to impart cooling to the gum at a level in the range found in typical commercial gum products. The addition of WS-5 will provide the gum compositions with cooling and breath freshening attributes that are enhanced. Enhancement includes stronger and longer lasting cooling and breath freshening benefits.

It should be appreciated that the methods and compositions of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

1.-17. (canceled)

18. A chewing gum composition comprising:
a) gum base,
b) flavor,
c) sweetening agent, and
d) a cooling composition comprising ethyl ester of N-[[5-methyl-2-(1-methylethyl)-cyclohexyl]carbonyl]glycine (WS-5) and at least one additional physiological cooling agent
wherein the cooling composition is present at a level sufficient to provide a WS-5 level of from about 0.3% to about 0.6% by weight of the chewing gum composition.

19. The chewing gum composition of claim 18 wherein the cooling composition is present at a level sufficient to provide a WS-5 level of at least 0.4% WS-5 by weight of the chewing gum composition.

20. The chewing gum composition of claim 18 wherein the cooling composition is present at a level sufficient to provide a WS-5 level of no more than 0.5% WS-5 by weight of the chewing gum composition.

21. The chewing gum composition of claim 18 wherein the cooling composition further comprises at least two physiological cooling agents in addition to WS-5.

22. The chewing gum composition of claim 18 wherein the at least one additional physiological cooling agent is selected from the group consisting of menthyl lactate; 3-l-menthoxypropane-1,2-diol; N-substituted p-menthane carboxamides; acyclic carboxamides; menthone glycerol ketals, l-isopulegol and mixtures thereof.

23. The chewing gum composition of claim 18 wherein the sweetening agent comprises: a) at least one sweetening agent selected from the group consisting of sugars, sugar alcohols, and mixtures thereof, and b) at least one high-intensity sweetener.

24. The chewing gum composition of claim 18 wherein the flavor is selected from the group consisting of mint flavor, spice flavor, and fruit flavor.

25. A chewing gum product comprising a gum composition made from gum base, flavor, and sweetening agent, and wherein the gum product includes a cooling composition comprising the ethyl ester of N-[[5-methyl-2-(1-methylethyl)-cyclohexyl]carbonyl]glycine (WS-5) at a level sufficient to provide a WS-5 level of by weight of the gum product.

26. The chewing gum product of claim 25 wherein the cooling composition is present at a level sufficient to provide a WS-5 level of at least 0.4% WS-5 by weight of the gum product.

27. The chewing gum product of claim 25 wherein the cooling composition is present at a level sufficient to provide no more than 0.5% WS-5 by weight of the gum product.

28. The chewing gum product of claim 25 wherein the product comprises a chewing gum pellet made from the gum composition and a coating on the pellet.

29. The chewing gum product of claim 25 wherein the product comprises a liquid center fill.

30. A chewing gum composition comprising:
a) about 5% to about 95% gum base,
b) about 0.1% to about 10% flavor,
c) about 10% to about 90% sweetening agent selected from the group consisting of sugars, sugar alcohols, and mixtures thereof, and
d) A cooling composition comprising WS-5 and an additional physiological cooling agent
wherein the cooling composition is present in an amount sufficient to provide the gum with a combination of good cooling properties and breath freshening properties without bitterness.

31. The chewing gum composition of claim 30 wherein the WS-5 is present in the cooling composition at a level sufficient to provide from about 0.3% to about 0.6% WS-5 by weight of the chewing gum composition.

32. The chewing gum composition of claim 31 wherein the composition further comprises menthol.
